(19) United States
(12) Patent Application Publication
(10) Pub. No.: US 2011/0321052 A1
(43) Pub. Date: Dec. 29, 2011

(54) MUTLI-PRIORITY COMMAND PROCESSING AMONG MICROCONTROLLERS

(75) Inventors: Thomas C. Long, Poughkeepsie, NY (US); Robert P. Makowicki, Staatsburg, NY (US)

(73) Assignee: International Business Machines Corporation, Armonk, NY (US)

(21) Appl. No.: 12/821,727

(22) Filed: Jun. 23, 2010

(51) Int. Cl. G06F 9/46

(52) U.S. Cl. 718/103

(57) ABSTRACT

A method, system and computer program product for serially transmitting processor commands of different execution priority. A front-end processor, for example, serially receives processor commands. A low-priority queue coupled to the front-end processor stores low-priority commands, and a high-priority queue coupled to the front-end processor stores high-priority commands. A controller enables transmission of commands from either the low-priority queue or the high-priority queue for execution.

### BACKGROUND

The present invention relates generally to processing multi-priority commands among back-end processors. More specifically, the present invention relates to serially transmitting processor commands of different execution priority to back-end processors.

For high-end servers, command and control processors for Power/Thermal field replaceable units (FRUs) are generally chosen based on such features as expected longevity, small footprint, and low cost. Using small, inexpensive microcontrollers for back-end processors saves cost on a per unit basis in power components.

The command and control functions in FRUs are typically performed by one or more of these small, inexpensive microcontrollers. For FRUs with multiple microcontrollers, one controller is often the primary (front-end) microcontroller, and the remaining ones are collectively called back-end processors (BEPs).

In a FRU with one or more BEPs, the front-end microcontroller typically performs cyclic monitoring of the BEP functions, sometimes referred to as EDFI (error detection and fault isolation), and caches the BEP information (state data and sensor values) in front-end RAM, from which location it can be retrieved by an administration application on the application's own schedule. If the administration application needs to send a real time command to a BEP (e.g., to change motor speed), the front-end microcontroller will typically respond immediately to the administration application with a good return code. The front-end controller will then manage the transmission of the command to the BEP. The administration application typically queries the status at a later time to determine whether the real-time (high priority) command was successful.

Increased use of BEPs has led to various back-end communication issues. The basic problem is coordinating the multiple processes which all desire to communicate with a BEP. Specifically, situations arise in which non-periodic, high priority commands must be sent to a BEP. Since the front-end microcontroller is generally engaged in routine cyclic monitoring function at all times, access to the serial port must be coordinated to avoid interference. One example of a high-priority command is the case where the front-end microcontroller determines that a state change command must be sent to a BEP. Another example of such a command is to change motor speed. In addition, there is a problem of handling nearly simultaneous high-priority commands, e.g. high-priority commands occur at nearly the same time.

The most direct solution to this problem is to use a front-end microcontroller which incorporates a large number of serial ports. With one serial port dedicated to each BEP, the problem of managing communications becomes simpler. However, this hardware-based solution, with its associated higher cost and additional board space, is not always practical.

### SUMMARY

An example embodiment of the present invention is a system for serially transmitting processor commands of different execution priority. The system includes a front-end processor configured to serially receive processor commands. A plurality of command queues are coupled to the front-end processor. The command queues include a low-priority queue configured to store low-priority commands and a high-priority queue configured to store high-priority commands and/or sequences of high-priority commands. A controller is configured to enable transmission of commands from only one of the command queues.

Another example embodiment of the invention is a method for serially transmitting processor commands of different execution priority. The method includes storing low-priority commands in a low-priority queue, and storing high-priority commands in a high-priority queue. A receiving operation receives the commands by a front-end processor. A transmitting operation transmits the received commands from one of either the low-priority queue or the high-priority queue for execution at a back-end processor.

Yet another example embodiment of the invention is a computer program product for serially transmitting processor commands of different execution priority. The program code is configured to store low-priority commands in a low-priority queue, store high-priority commands in a high-priority queue, receive the commands by a front-end processor, and transmit the received commands from one of either the low-priority queue or the high-priority queue for execution at a back-end processor.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows an example computer system for processing BEP commands of different priority, as contemplated by the present invention.

FIG. 2 shows another example system contemplated by the invention.

FIG. 3 shows an example queue-based controller implemented with the capability to manage standard, low priority cyclic monitoring communications, as well as non-periodic high priority communications.

FIG. 4 shows a static queue architecture utilized by an embodiment of the present invention.

FIG. 5A shows a low priority queue in an ENABLED (normal) state.

FIG. 5B shows a low priority queue in a SUSPENDED state, a desired high priority command and/or sequences of high-priority commands activated, and a high priority queue in an ENABLED state.

FIG. 5C shows a high priority command deactivated, and a high priority queue remaining in an ENABLED state until the command completes.

FIG. 5D shows a high priority queue in a SUSPENDED state and a low priority queue resuming normal operation (ENABLED state).

FIG. 6 shows an example process for serially transmitting processor commands of different execution priority contemplated by the present invention.

FIG. 7 shows an embodiment of the invention where the high-priority queue is used to send sequences of commands, rather than single high-priority commands.

### DETAILED DESCRIPTION

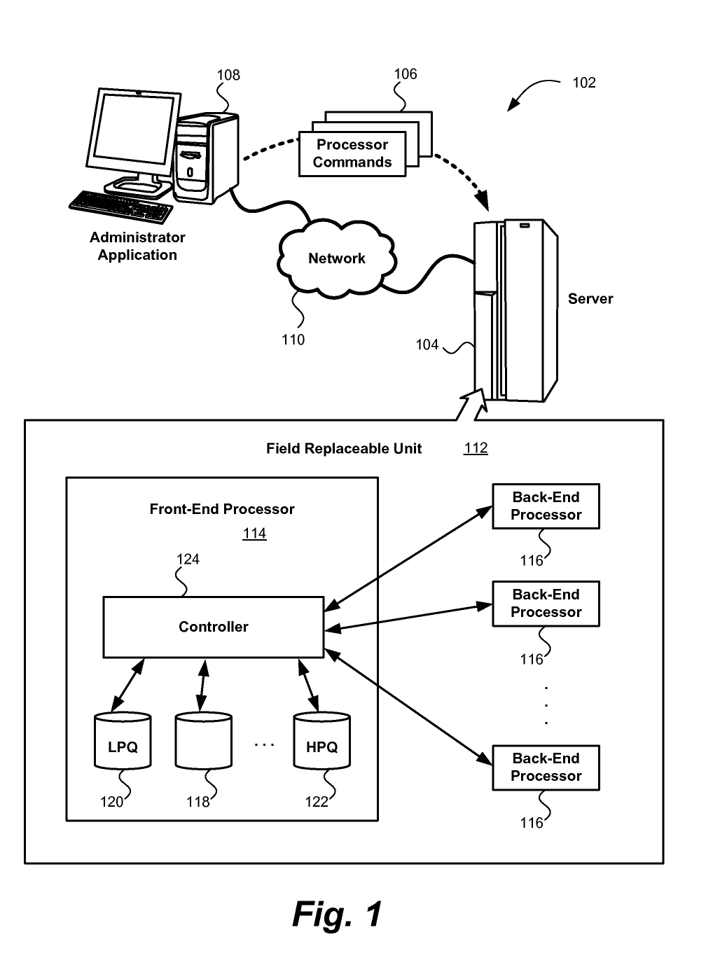

The present invention is described with reference to embodiments of the invention. Throughout the description of the invention reference is made to FIGS. 1-6.

As discussed in detail below, embodiments of the present invention include architecture for managing asynchronous serial communication among multiple micro-controllers performing command and control function on a Power/Thermal component in a high-availability, fault-tolerant, high-performance server. This novel design can allow fully asynchronous, interrupt-driven communication which permits a firmware application to run freely while communication is taking place.

Additionally, the design can support the ability to manage a set of commands, which are sent with “normal” priority, on a predetermined, periodic schedule (routine cyclic communication). The design may support the ability to manage a set of commands which may be sent on an unpredictable schedule (in response to changing events, or in response to external sources), whose priority can be elevated such they are preferentially sent in place of the normal priority commands.

Embodiments may support the ability to communicate between a “front-end” micro-controller and any number of “back-end” micro-controllers, including support for multiplexed communications. These functions may be implemented as a common code library, allowing the use of the functions by any developer in a team environment.

As discussed below, embodiments of the invention can achieve such objectives without the use of a dynamic queue, and without a complicated prioritization algorithm. Such approaches generally result in code that is much more complex and prone to runtime errors, such as memory leaks. Rather than a more complicated prioritization scheme using dynamic memory management or a numerical prioritization scheme, a simple two-queue approach, for instance, is used; one high priority queue, one low (normal) priority queue. Such a solution avoids alternative hardware-based configurations that may require additional costs to implement.

FIG. 1 shows an example computer system 102 for processing commands of different priority, as contemplated by the present invention. As illustrated, a server 104 receives processor commands 106 from an administrator application executing on an administrator computer 108 over a computer network 110. The server 104 may be a high-availability, fault-tolerant, high-performance server. Although the administrator computer 108 is shown outside the server 104, it is contemplated that the administrator computer 108 may be located within the server computer 104.

The processor commands 106 include command and control directives for field replaceable units (FRUs) 112 within the server 104. Furthermore, the commands 106 may have different execution priority. For example, low-IBM priority commands may include periodic monitoring commands, while high-priority commands may require substantially real-time execution.

As discussed in more detail, the commands are communicated asynchronously and serially over the network 110 to the intended FRU 112. A front-end processor 114 at the FRU 112 receives the commands 106 from the administrator application. The front-end processor 114 then forwards the commands 106, as necessary, to back-end processors 116.

As shown, the front-end processor 114 may include a plurality of command queues 118. Each queue 118 is configured to store commands 106 of a particular priority level. For example, a low-priority queue 120 coupled to the front-end processor is configured to store low-priority commands. Likewise, a high-priority queue 122 coupled to the front-end processor is configured to store high-priority commands. In a particular embodiment, command queues 118 are of fixed memory size. Furthermore, the command queues 118 may be circular queues such that last elements in the queues point to first elements of the queues.

In one embodiment, each queue 118 may have a queue status of enabled or suspended. Furthermore, commands stored in the queues 118 may have a state of active or idle.

The front-end processor 114 also includes a controller configured to enable serial transmission of commands from only one of the queues 118 for execution at the back-end processors 116. In one embodiment, the controller may be configured to enable transmission of commands in the active state of a queue in the enabled status to the back-end processors 116.

The controller 124 may be configured to initially set a queue status of the low-priority queue to an enabled status, and set the queue status of the high-priority queue to a suspended status. Additionally, the controller 124 may initially set the command state of the low-priority commands stored in the low-priority queue to an active state, and set the command state of the high-priority commands stored in the high-priority queue to an idle state. Thus, only the low-priority commands that are active in the low-priority queue 120 are initially transmitted to the back-end processors 116.

The controller 124 may be additionally configured to, after receipt of a high-priority command, set the queue status of the low-priority queue 120 to the suspended status, set the queue status of the high-priority queue 122 to the enabled status, and set the command state of the high-priority command and/or sequences of high-priority commands received to the active state. When this occurs, the low-priority commands in the low-priority queue 120 stop being transmitted to the back-end processors 116. Moreover, the active command(s) in the high-priority queue 122 are transmitted by the controller 124 to the back-end processors 116.

Thus, the example system assists in managing asynchronous serial communication among one or more back-end processors, such as microcontrollers, performing command and control function on a field replaceable unit, such as a power/thermal component in a high-availability, fault-tolerant, high-performance server. Embodiments of the inventor may support one or more of the following features: (a) fully asynchronous, interrupt-driven communication which allows the firmware application to run freely while communication is taking place; (b) the ability to manage a set of commands, which are sent with “normal” priority, on a predetermined, periodic schedule (routine cyclic communication); (c) the ability to manage a set of commands which may be sent on an unpredictable schedule (in response to changing events, or in response to external sources), whose priority can be elevated such they are preferentially sent in place of the “normal” priority commands; (d) the ability to support communications between the “front-end” microcontroller and any number of “back-end” microcontrollers, including support for multiplexed communications; and (e) implementation of these functions as a common code library, allowing the use of the functions by any developer in a team environment.

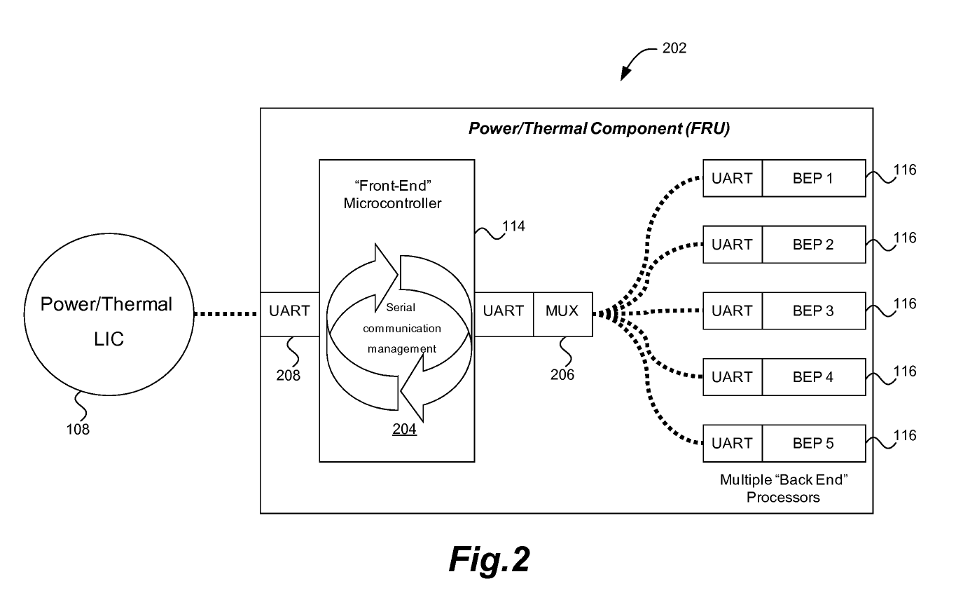

Turning now to FIG. 2, another example system 202 contemplated by the invention is shown. The system supports multiple back-end processors (BEPs) 116, such as MDAU, 39912-based VRM, 36912-based BPR BEP (AC/DC, DC/DC, and IBF), 3687 (in the MDARE, and in the new BPR for z-Gryphon and P7), and 2166-based quad-VRM micro-controllers. The front-end processor 114 includes serial communication software functions supporting both routine cyclic communication among the back-end processors 116, and high priority, “real time” communication among the back-end processors 116. In one embodiment, the communication software functions are implemented as a common code library, allowing their use by any developer on the team.

As further detailed below, the system 202 includes queue-based communication management controller 204. The controller 204 uses multiple static queues, each having a different (fixed) priority. Commands in each queue have two basic states, active and inactive, allowing control at the command level. The controller 204 controls all queues, ensuring that only one queue is enabled at a time.

Serially communicated command and control instructions are send from the administrator application 108 directly to the front-end processor 114 (serial communications are shown as dotted lines in the Figures). The front-end processor 114 handles all communication with the back-end processors 116, and caches all back-end processor state data for retrieval by administrator application 108 at the administrator application's convenience.

The static queue approach of the controller 204 avoids the complexity and associated problems that would result from using dynamic memory management or dynamic prioritization. The queues are created at time zero, with their elements initialized at that time. The number of queues, and each queue's (fixed) priority, are determined at that time. For simplicity in describing the operation of the queues, the description below will be limited to two queues, of priority “low” and “high”, although the concept is extendable to any number of queues, each with its associated priority.

The system 202 includes a port multiplexer 206 configured to support multiplexed serial communications with numerous microcontroller serial ports. The controller 204 manages multiplexed communications to all BEPs 116 on that serial channel. One queue controler 204 is defined per serial port 208.

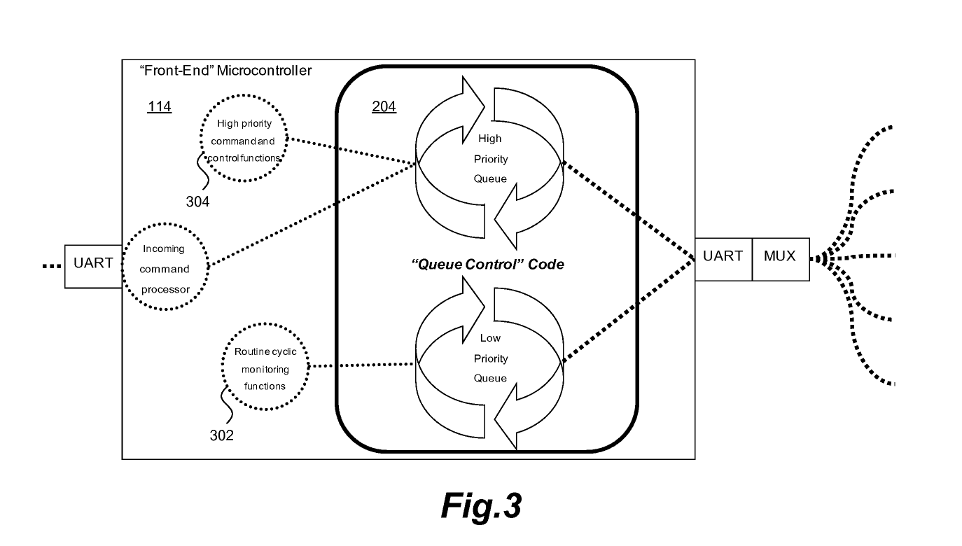

As shown in FIG. 3, the queue-based controller 204 is implemented with the capability to manage standard, low priority cyclic monitoring communications (EDFI) 302, as well as non-periodic high priority communications 304. Furthermore, the back-end queue can be suspended for high-priority tasks, such as flash updates, which take over the serial port for the duration of the task. The system also supports pseudo-commands that perform queue-related actions, such as an instruction to wait one second before proceeding to the next command. In doing so, the infrastructure code to manage back-end communications can accommodate the different time bases which may be used in different applications (i.e., the frequency of timer interrupts, and the granularity of the runtime counter).

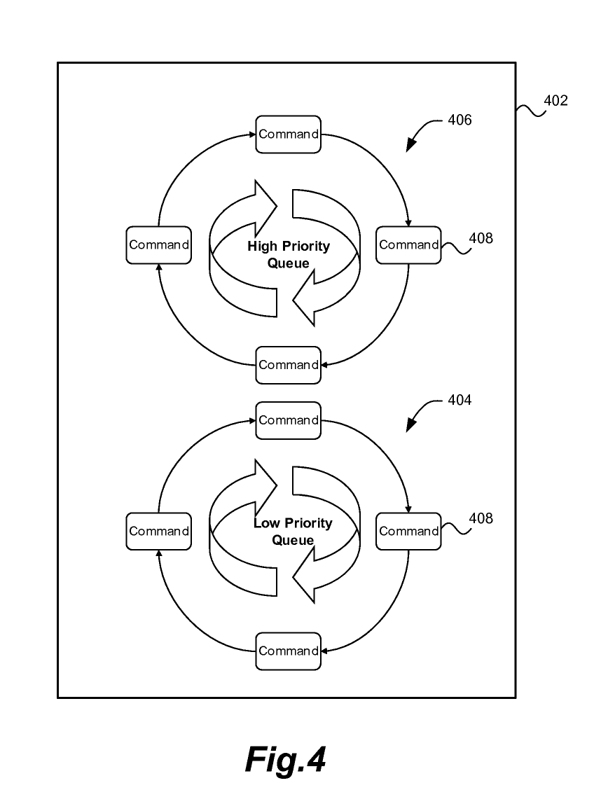

FIG. 4 shows a static queue architecture 402 utilized by an embodiment of the present invention. In this embodiment, the queue architecture 402 includes a low-priority queue 404 and a high-priority queue 406. The queue elements are static, rather than dynamic. That is, the queue elements are fixed. The static queue design avoids dynamic memory management, which can lead to memory leaks and other problems, due to its complexity. Furthermore, since all commands that may be passed on to the BEP in response to a LIC command are known at design time, it is possible to initialize both queues 404 and 406 at time zero with static members.

Both the high priority queue 406 and low priority queue 404 have statically linked command elements 408, but their default states are different. The low priority queue status is ENABLED by default, and its command elements 408 are ACTIVE by default. The high priority queue status is SUSPENDED by default, and its command elements 408 are IDLE by default. The queue controller determines when a high priority command and/or sequences of high-priority commands must be sent, and “sends” them by setting the high priority queue to ENABLED and the target command to ACTIVE.

The queue controller handles the details of suspending the low priority queue 404, enabling the high priority queue 406, and sending the high priority command and/or sequences of high-priority commands. When the high priority command and/or sequences of high-priority commands complete, it sets the command state back to IDLE, suspends the high priority queue, and resumes the low priority queue's operation.

In one embodiment of the invention, the operational architecture of the system can be abstracted into three data structure levels utilized by the controller. Each data structure level represents a level in the hierarchy of queue management. The first level data structure is the queue control structure for a serial port. The second level data structure is the queue(s) within the control structure. The third level data structure is the chained command elements that make up each queue.

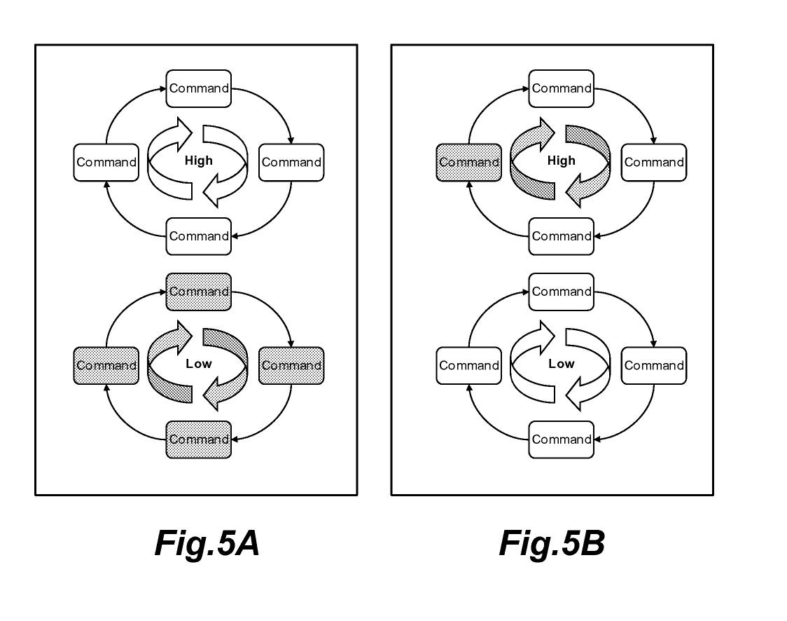

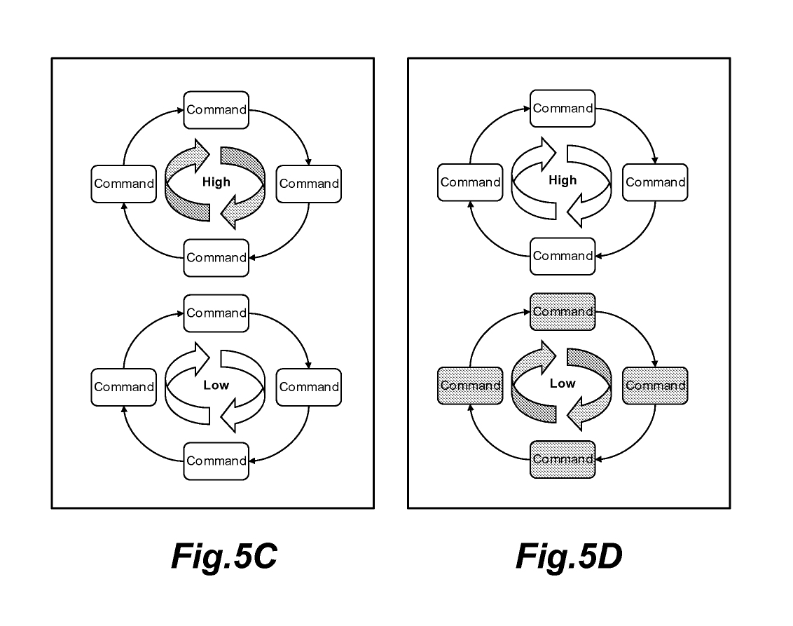

As mentioned above, the queue-based serial communications controller may be set up at time zero. The first decision is to identify the number of priority levels in the system, as this will determine the number of queues. With reference now to FIGS. 5A-5D, an example two-priority-level system is described (“low” and “high”), requiring two queues: a low priority queue (LPQ) and a high priority queue (HPQ).

The LPQ is initialized with the commands to perform routine cyclic monitoring of the BEP(s), while the HPQ contains the set of commands that are not sent periodically, but instead need to be processed in real time. Examples of such high-priority commands include power-on or power-off commands, or motor speed adjust commands.

The queues are static, i.e., there is no dynamic allocation or freeing of memory. Each queue consists of a circular chain (linked list), where each command's “next” member points to the next command in the chain such that the final command in the chain wraps back to the first. The queue elements are set up at time zero and remain in place throughout the running of the application. This can be done because the developer knows, up front, which commands can be sent to the BEP. The basic difference between the LPQ and the HPQ is that the LPQ is ENABLED by default, and its commands are in ACTIVE state by default. In contrast, the HPQ is SUSPENDED by default, and its commands are in IDLE state by default.

For example, in a FRU with three BEPs, the LPQ may contain the following commands:

Get Fru Status (mux address 1)

Get Fru Status (mux address 2)

Get Fru Status (mux address 3)

Sleep 1 second

The HPQ may contain the following commands:

Alter Motor Speed (mux address 1)

Power On (mux address 2)

Power Off (mux address 2)

Power On (mux address 3)

Power Off (mux address 3)

Different applications may use different timer interrupt periods, as well as different runtime counter granularity. The queue control code takes this into account, enabling it to accurately measure both command timeouts and intentional delays (such as the 1-second sleep command above). The queue control code is be initialized at time zero with the timer interrupt period and the runtime counter granularity.

Access to the serial port is coordinated by the queue control functions. As shown in FIG. 5A, the LPQ is LPQ, ENABLED by default (represented by shaded regions), and begins operating when the application starts. If ACTIVE, the current command is processed, a response is received and the data is saved, and the next ACTIVE command is loaded. The LPQ continues to execute in this manner until the controller determines that a high priority command must be sent.

As shown in FIG. 5B, the application “sends” a high priority command by calling a specific queue control function, with the command element as argument. This function sets the high priority command state to ACTIVE, and begins the smooth transition to set the LPQ to SUSPENDED and the HPQ to ENABLED (again represented by the shaded region). The HPQ then traverses its chain of commands until it finds one in the ACTIVE state. That command is sent, a response is received, and its data is saved. As illustrated in FIG. 5C, the active command is then set to IDLE. As shown in FIG. 5D, if no other ACTIVE command is found in the HPQ chain, the queue control code changes the HPQ from ENABLED to SUSPENDED, and changes the LPQ back to ENABLED. The LPQ resumes normal cyclic monitoring operation.

In one embodiment, all activities related to back-end communication are performed by the queue controller, in common code, transparent to the application. When the application “sends” a high priority command, it actually calls an API function which sets the target command to ACTIVE and performs the smooth changeover to set the HPQ to ENABLED. The queue controller also restores the LPQ to ENABLED after the HPQ transaction is complete. The firmware's application continues to run freely during the queues' operation.

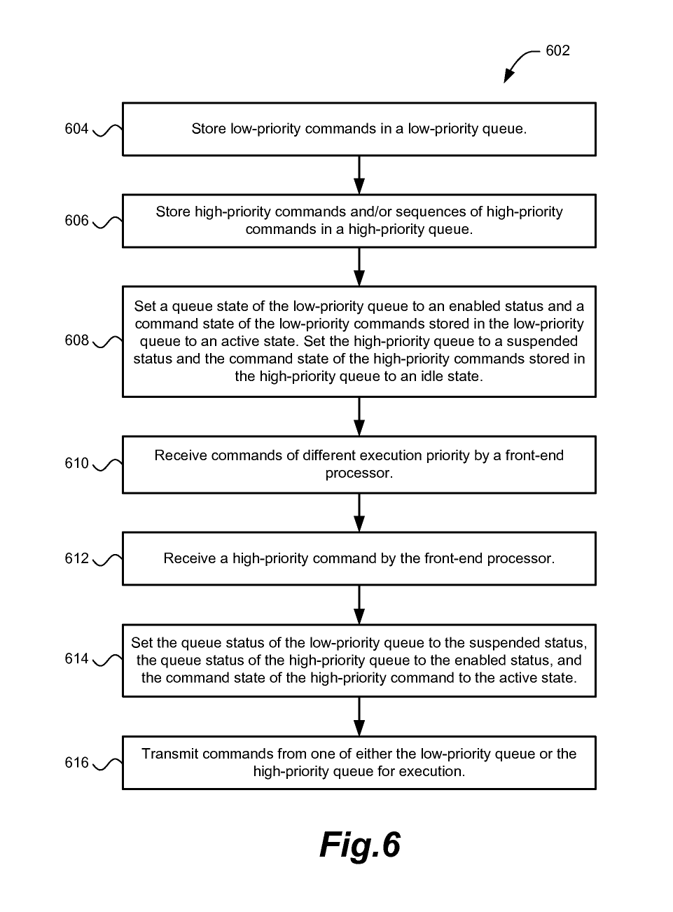

Turning now to FIG. 6, an example process 602 for serially transmitting processor commands of different execution priority contemplated by the present invention is shown.

The process starts at storing operation 604, where low-priority commands are stored in a low-priority queue. At storing operation 606, high-priority commands and/or sequences of high-priority commands are stored in a high-priority queue. As discussed above, the low-priority queue and the high-priority queue may be circular queues such that last elements in the queues point to first elements of the queues. Furthermore, the queues may be of fixed memory size.

At setting operation 608, a queue state of the low-priority queue is initially set to an enabled status, and a command state of the low-priority commands stored in the low-priority queue is set to an active state. Furthermore, the queue state of the high-priority queue is initially set to a suspended status, and the command state of the high-priority commands stored in the high-priority queue is set to an idle state.

Next, at receiving operation 610, commands of different execution priority are received by a front-end processor. At receiving operation 612, a high-priority command is received by the front-end processor.

After the high-priority command is received, a setting operation 614 sets the queue status of the low-priority queue to the suspended status, the queue status of the high-priority queue to the enabled status, and the command state of the high-priority command to the active state.

At transmitting operation 616, commands from only one of the queues (either the low-priority queue or the high-priority queue) are serially transmitted for execution at a back-end processor. As detailed above, the controller serially transmits commands in the active state of a queue in the enabled status to the back-end processor.

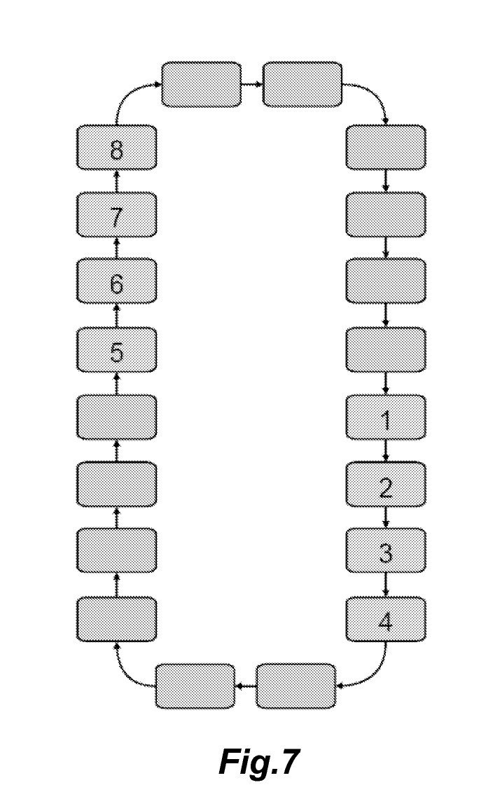

FIG. 7 shows an embodiment of the invention where the high-priority queue is used to send sequences of commands, rather than single high-priority commands. The high priority queue can be set up with individual commands, and/or command sequences, at time zero. At runtime, a command sequence is triggered by activating all commands in the sequence, and enabling the high priority queue. The first command in the sequence is sent, and since the commands are chained in a linked list, the sequence of commands is executed in order.

As shown, the queue controller first sends realtime commands 1 through 4 in sequence, followed by realtime commands 5 through 8. When the realtime command sequences are completed, the queue controller re-enables the standard priority command sequence.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention has been described, it will be understood that those skilled in the art, both now and in the future, may make various improvements and enhancements which fall within the scope of the claims which follow. Thus, the claims should be construed to maintain the proper protection for the invention first described.

What is claimed is:

1. A system comprising:
a front-end processor configured to serially receive processor commands;
a plurality of command queues coupled to the front-end processor, the command queues including a low-priority queue configured to store low-priority commands and a high-priority queue configured to store high-priority commands;
a controller configured to enable transmission of commands from only one of the command queues.

2. The system of claim 1, further comprising:
at least one back-end processor; and
wherein the controller is configured to transmit the commands to the at least one back-end processor.

3. The system of claim 2, wherein transmission of commands to the at least one back-end processor is performed serially.

4. The system of claim 1, wherein the command queues are of fixed memory size.

5. The system of claim 1, wherein the command queues are circular queues such that last elements in the queues point to first elements of the queues.

6. The system of claim 1, wherein the controller is configured to initially set a queue status of the low-priority queue to an enabled status, set a command state of the low-priority commands stored in the low-priority queue to an active state, set the queue status of the high-priority queue to a suspended status, and set the command state of the high-priority commands stored in the high-priority queue to an idle state.

7. The system of claim 6, wherein, after receipt of a high-priority command, the controller is configured to set the queue status of the low-priority queue to the suspended status, set the queue status of the high-priority queue to the enabled status, and set the command state of the high-priority command to the active state.

8. The system of claim 7, wherein the controller is configured to enable transmission of commands in the active state of a queue in the enabled status.

9. The system of claim 1, wherein the low-priority commands include periodic monitoring commands and the high-priority commands require substantially real-time execution.

10. The system of claim 1, wherein the high-priority queue is further configured to store sequences of high-priority commands.

11. A method for serially transmitting processor commands of different execution priority, the method comprising:
storing low-priority commands in a low-priority queue;
storing high-priority commands in a high-priority queue;
receiving the commands by a front-end processor; and
transmitting the commands from one of the low-priority queue and the high-priority queue for execution at a back-end processor.

12. The method of claim 11, wherein transmission of the commands to the one back-end processor is performed serially.

13. The method of claim 11, wherein the low-priority queue and the high-priority queue are of fixed memory size.

14. The method of claim 11 wherein the low-priority queue and the high-priority queue are circular queues such that last elements in the queues point to first elements of the queues.

15. The method of claim 11, further comprising initially setting a queue state of the low-priority queue to an enabled status, a command state of the low-priority commands stored in the low-priority queue to an active state, the queue state of the high-priority queue to a suspended status, and the command state of the high-priority commands stored in the high-priority queue to an idle state.

16. The method of claim 15, further comprising setting, after receipt of a high-priority command, the queue status of the low-priority queue to the suspended status, the queue status of the high-priority queue to the enabled status, and the command state of the high-priority command to the active state.

17. The method of claim 16, wherein transmitting the processor commands includes serially transmitting commands in the active state of a queue in the enabled status to the back-end processor.

18. The method of claim 11, wherein the high-priority queue is further configured to store sequences of high-priority commands.

19. A computer program product for serially transmitting processor commands of different execution priority, the computer program product comprising:
a computer readable storage medium having computer readable program code embodied therewith, the computer readable program code configured to:
store low-priority commands in a low-priority queue;
store high-priority commands in a high-priority queue;
receive the commands by a front-end processor; and
transmit the commands from one of the low-priority queue and the high-priority queue for execution at a back-end processor.

20. The computer program product of claim 19, wherein transmission of the commands to the one back-end processor is performed serially.

21. The computer program product of claim 19, wherein the low-priority queue and the high-priority queue are of fixed memory size.

22. The computer program product of claim 19, wherein the low-priority queue and the high-priority queue are circular queues such that last elements in the queues point to first elements of the queues.

23. The method of claim 19, wherein the high-priority queue is further configured to store sequences of high-priority commands.
